(19) United States
(12) Patent Application Publication
(10) Pub. No.: US 2011/0015367 A1
(43) Pub. Date: Jan. 20, 2011

(54) UNSATURATED POLY(ESTER-AMIDE) AND POLY(ETHER ESTER AMIDE) BIOMATERIALS

(75) Inventors: Chih-Chang Chu, Ithaca, NY (US); Ramaz Katsarava, Tbilisi, GA (US); Kai Guo, Brookline, MA (US)

Correspondence Address: HODGSON RUSS LLP;THE GUARANTY BUILDING, 140 PEARL STREET, SUITE 100, BUFFALO, NY, 14202-4040, US

(73) Assignee: Cornell University, Ithaca, NY (US)

(21) Appl. No.: 12/591,488

(22) Filed: Nov. 20, 2009

Related U.S. Application Data
(63) Continuation-in-part of application No. 11/587,530, filed on Oct. 25, 2006.
(60) Provisional application No. 60/576,293, filed on Jun. 3, 2004.
(60) Provisional application No. 60/638,385, filed on Dec. 27, 2004.

(51) Int. Cl. C08G 69/44

(52) U.S. Cl. 528/292

(57) ABSTRACT

Functionalized poly(ester-amides) and poly(ether ester amides) polymers having the structural formula:

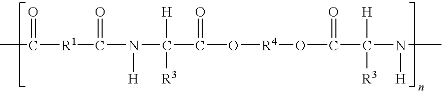

wherein R¹ is (C₂-C₂₈)alkylene, or (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt;
R³ is selected from the group consisting of hydrogen, (C₁-C₆)alkyl, and (C₆-C₁₀)aryl (C₁-C₆)alkyl; and
R⁴ is selected from the group consisting of (C₂-C₂₈)alkyloxy, (C₂⁻C₂₈)alkylene substituted with a side chain selected from the group consisting of (2-carboxyethyl)thio, (2-hydroxethyl) thio, (2-aminoethyl)thio and (2-aminoethyl)thio hydrochloride salt, and —C₂H₄(OC₂H₄)ₓ;
x ranges from 2-4;
n ranges from 5 to 150; and
wherein at least one of R1 and R4 attaches a functional group.

### CROSS-REFERENCE TO RELATED APPLICATIONS

This application is a continuation-in-part of U.S. patent application Ser. No. 11/587,530. U.S. patent application Ser. No. 11/587,530 claims the benefit of U.S. Provisional Patent Application No. 60/576,293, filed Jun. 3, 2004 and of U.S. Provisional Patent Application No. 60/638,385 filed Dec. 27, 2004, the whole of each are incorporated herein by reference.

The invention was made at least in part with United States Government support under United States Department of Commerce Prime Grant Award No. 99-27-07400 pursuant to a subagreement with The National Textile Center. The United States Government has certain rights in the invention.

### TECHNICAL FIELD

This invention relates to functionalized poly(ester-amides) and poly(ether ester amides) and biomaterials useful as biodegradable carriers for drugs or other bioactive agents.

### BACKGROUND OF THE INVENTION

Poly(ester-amide)s (PEAs) are polymers synthesized from non-toxic amino acids, diols and dicarboxylic acids and are composed of both ester and amide blocks. PEAs have been widely studied because they combine the favorable properties of both polyesters and polyamides, i.e., they possess not only good biodegradability but also good mechanical and processing properties, e.g., thermal stability, tensile strength and modulus. Amino acids, due to their abundant availability from natural sources and the potential biodegradability of their derivatives under certain enzymatic catalyzed conditions, have often been chosen as the source for the amine group for biodegradable poly(ester-amide)s. It has also been reported that the inclusion of phenylalanine in the backbone of the PEAs can enhance their biodegradability in the presence of chymotrypsin.

In an effort to expand the scope of amino acid-based PEA biomaterials to provide improved solubility, hydrophilicity, chain flexibility, and biodegradability, a family of amino acid-based biomaterials, poly(ether ester amides) (PEEAs), have been designed and synthesized by solution polycondensation. Instead of diols such as butanediol, oligo(ethylene glycol)s (OEG) may be used as one of the building blocks to form PEEA.

The resulting PEEAs have well-defined blocks of not only ester and amide linkages, but also contain an ether linkage. Depending on the type and concentration of monomers used, such as a-amino acid, saturated, or unsaturated dicarboxylic acids, different dialcohols and OEG, the synthesized PEEAs can have a variety of different thermal, mechanical, and biological properties to meet the needs of a wide range of applications in the pharmaceutical, biomedical, and tissue engineering industries. The presence of additional ether linkages in the backbones of these OEG-based PEEAs were found to even further enhance the hydrophilicity, flexibility, and biodegradability of the polymers when compared to diol-based PEAs. Guo et al., Copolymers of Unsaturated and Saturated Poly(ether ester amide)s: Synthesis, Characterization, and Biodegradation, Journal of Applied Polymer Science, Vol. 110,1858-1869 (2008).

PEAs and PEEAs generally do not have any functional groups located either along the PEA backbone chain or as pendant groups. However, the presence of functional pendant groups within the PEA backbone or as pendant groups can significantly expand the utility of PEAs and PEEAs. For example, the presence of functional groups along the backbone will allow further chemical conjugations with a wide variety of drugs, biologically agents and/or active agents, thereby providing a novel route toward functionalized biomaterials.

In one approach, Gillies et al., Characterization, and Functionalization of Poly(ester amide)s with Pendant Amine Functional groups (J Polym Sci, Part A: Polym Chem 2008; 46(19):6376-6392) produce PEAs having a free functional group. Varying percentages of lysine are incorporated into PEAs comprised of L-phenylalanine, 1,4-butanediol, and succinic acid by adjusting the ratio of protected—L-lysine and L-phenylalanine derived monomers. By incorporating lysine into the backbone of PEA in this manner, the —NH₂ side chain of lysine is capable of serving as a free pendant amine group in the PEA.

However, the starting materials utilized by Gillies et al are expensive. The steps used to produce the Gillies et al PEA require the use of protective groups and are quite complicated. Moreover, there are limits as to where functional groups can be positioned in the Gillies et al. PEA.

### SUMMARY

The inventors of the present application have discovered a way to incorporate functional pendant groups within the backbone of PEA or PEEA by reacting unsaturated PEA (UPEA) or unsaturated PEEA (UPEEA) with a thiol-based compound containing a functional group. The thiol group attaches UPEA or UPEEA via double bond functionality, resulting in a functional pendant group present along the backbone of PEA or PEEA. The presence of a functional pendant group on UPEA or UPEEA compounds via double bond functionality allows for the attachment of additional functional groups, drugs, and biologically active agents to these polymers.

In one embodiment, the invention relates to a polymer having the structural formula:

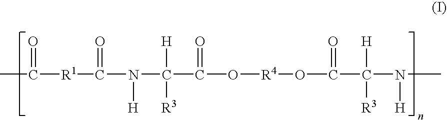

wherein R¹ is (C₂-C₂₈)alkylene, or (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt;

R³ is selected from the group consisting of hydrogen, (C₁-C₆)alkyl, and (C₆-C₁₀)aryl (C₁-C₆)alkyl; and

R⁴ is selected from the group consisting of (C₂-C₂₈)alkyloxy, (C₂-C₂₈)alkylene, (C₂-C₂₈)alkyloxy substituted with a side chain selected from the group consisting of (2-carboxyethyl)thio, (2-hydroxethyl)thio, (2-aminoethyl)thio and (2-aminoethyl)thio hydrochloride salt, and —C₂H₄(OC₂H₄)ₓ, or (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt, and —C₂H₄(OC₂H₄)ₓ;

x ranges from 2-4;

n ranges from 5 to 150; and

wherein at least one of R1 and R4 attaches a functional group.

A second embodiment of the invention relates to a polymer having the structural formula:

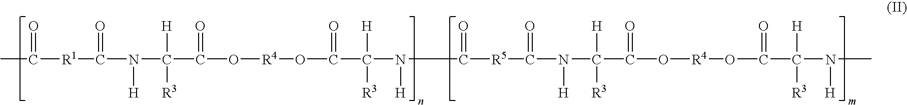

wherein R¹ is (C₂-C₂₈)alkylene; or (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt;

R³ is selected from the group consisting of hydrogen, (C₁-C₆)alkyl, and (C₆-C₁₀)aryl;

R⁴ is selected from the group consisting of (C₂-C₂₈)alkyloxy, (C₂-C₂₈)alkylene, (C₂-C₂₈)alkyloxy substituted with a side chain selected from the group consisting of (2-carboxyethyl)thio, (2-hydroxethyl)thio, (2-aminoethyl)thio and (2-aminoethyl)thio hydrochloride salt, and —C₂H₄(OC₂H₄)ₓ, or (C₂-C₂₈)alkylene substituted with a side chain selected from the group consisting of (2-carboxyethyl)thio, (2-hydroxethyl) thio, (2-aminoethyl)thio and (2-aminoethyl)thio hydrochloride salt, and —C₂H₄(OC₂H₄)ₓ;

R⁵ is (C₂-C₂₀)alkylene;

n ranges from 0.9 to 0.1;

m ranges from 0.1 to 0.9; and

wherein at least one of R1 and R4 attaches a functional group.

A third embodiment is a composition containing the polymers of the first and second embodiments.

The term “alkylene” is used herein as a linear saturated divalent to hydrocarbon radical.

The term “alkenylene” is used herein to mean a divalent branched or unbranched hydrocarbon chain containing at least one double bond in the main chain or in a side chain.

“Alkoxy” represents an alkyl group as defined above with the indicated number of carbon atoms attached through an oxygen bridge. Examples of alkoxy include, but are not limited to methoxy, ethoxy, n-propoxy, i-propoxy, n-butoxy, s-butoxy, t-butoxy, n-pentoxy, and s-pentoxy.

The molecular weights and polydisperities herein are determined by gel permeation chromatography using polystyrene standards. More particularly, number and weight average molecular weights (Mₙ and M_{w}) are determined using a Model 510 gel permeation chromatograph (Water Associates, Inc., Milford, Mass.) equipped with a high-pressure liquid chromatographic pump, a Waters 486 UV detector and a Waters 2410 differential refractive index detector. Tetrahydrofuran (THF) is used as the eluant (1.0 mL/min). The polystyrene standards have a narrow molecular weight distribution.

The term “biodegradable” is used herein to mean capable of being broken down by various enzymes such as trypsins, lipases and lysosomes in the normal functioning of the human body and living organisms (e.g., bacteria) and/or water environment.

The term “biomaterial” is used herein to mean a synthetic material used to function in intimate contact with living tissue.

The term “bioactive agent” is used herein to mean agent for delivery to cells, tissues or organs for nutrient or therapeutic effects. These include, but are not limited to nutrients, pharmaceuticals, drugs, peptides and oligo nucleotides.

The term “hydrogel” is used herein to mean a polymeric material which exhibits the ability to swell in water and to retain a significant portion of water within its structure without dissolution.

The term “biodegradable hydrogel” is used herein to mean hydrogel formed by cross-linking a polymer which is degraded by water and/or by enzymes found in nature.

The term “hydrogel precursor” is used herein to mean water soluble polymer that is photocrosslinkable in solution in a medium to form a hydrogel.

The term “photocrosslinking” is used herein to mean causing vinyl bonds to break and form cross-links by the application of radiant energy.

The term “Gel permeation chromatography (“GPC”)” refers to the separation method for the determination of molecular weight averages (Mn) and molecular weight distributions (PDI=Mw/Mn) of polymers.

The term “about” as used herein is meant to encompass variations of +/−2%, e.g., +/−0.5% or +/−0.1%.

The term “TosOH” means herein p-toluenesulfonic acid monohydrate.

The term “NEt3” means herein triethylamine.

The term “EtAc” means herein Ethyl acetate.

The term “TFA” means herein trifluoroacetic acid.

The term “DMA” means herein N,N-Dimethylacetamide.

### DETAILED DESCRIPTION

In one embodiment, the invention relates to a polymer having the structural formula:

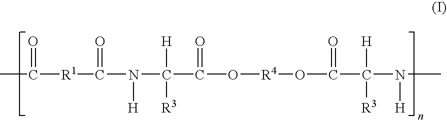

wherein R¹ is (C₂-C₂₈)alkylene, or (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt;

R³ is selected from the group consisting of hydrogen, (C₁-C₆)alkyl, and (C₆-C₁₀)aryl (C₁-C₆)alkyl; and

R⁴ is selected from the group consisting of (C₂-C₂₈)alkyloxy, (C₂⁻C₂₈)alkylene, (C₂-C₂₈)alkyloxy substituted with a side chain selected from the group consisting of (2-carboxyethyl)thio, (2-hydroxethyl)thio, (2-aminoethyl)thio and (2-aminoethyl)thio hydrochloride salt, and —C₂H₄(OC₂H₄)ₓ, or (C₂⁻C₂₈)alkylene substituted with a side chain selected from the group consisting of (2-carboxyethyl)thio, (2-hydroxethyl)thio, (2-aminoethyl)thio and (2-aminoethyl)thio hydrochloride salt, and —C₂H₄(OC₂H₄)ₓ;

x ranges from 2-4;

n ranges from 5 to 150; and

wherein at least one of R1 and R4 attaches a functional group.

In one facet of this embodiment, the polymer of formula (I) is UPEA substituted with a side chain selected from the group consisting of (2 carboxyethyl)thio, (2-hydroxethyl)thio, (2-aminoethyl)thio, and (2-aminoethyl)thio hydrochloride salt produced based polymer.

The UPEAs are prepared by solution polycondensation of either (1) di-p-toluenesulfonic acid salts of bis(alpha-amino acid) diesters of unsaturated diol and di-p-nitrophenyl ester of saturated dicarboxylic acid or (2) di-p-toluenesulfonic acid salts of bis(alpha-amino acid) diesters of saturated diol and di-nitrophenyl ester of unsaturated dicarboxylic acid or (3) di-p-toluenesulfonic acid salt of bis(alpha-amino acid) diesters of unsaturated diol and di-nitrophenyl ester of unsaturated dicarboxylic acid.

Salts of p-toluenesulfonic acid are known for use in synthesizing polymers containing amino acid residues. The aryl sulfonic acid salts are used instead of the free base because the aryl sulfonic acid salts of bis(alpha-amino acid) diesters are easily purified through recrystallization and render the amino groups as unreactive ammonium tosylates throughout workup.

The di-p-nitrophenyl esters of unsaturated dicarboxylic acid can be synthesized from p-nitrophenol and unsaturated dicarboxylic acid chloride, e.g., by dissolving triethylamine and p-nitrophenol in acetone and adding unsaturated dicarboxylic acid chloride dropwise with stirring at −78° C. and pouring into water to precipitate product. Suitable acid chlorides are dicarboxylic acyl chlorides including, for example, fumaric, maleic, mesaconic, citraconic, glutaconic, itaconic, ethenyl-butane dioic and 2-propenyl-butanedioic acid chlorides.

The di-p-toluenesulfonic acid salts of bis(alpha-amino acid) diesters of unsaturated diol can be prepared by admixing amino acid, aryl sulfonic acid (e.g., p-toluenesulfonic acid monohydrate) and unsaturated diol in toluene, heating to reflux temperature, until water evolution is minimal, then cooling. The unsaturated diols include, for example, 2-butene-1,4-diol and 1,18-octadec-9-en-diol.

Di-p-nitrophenyl esters of saturated dicarboxylic acid and di-p-toluenesulfonic acid salts of bis(alpha-amino acid) diesters of saturated diol can be prepared as described in U.S. Pat. No. 6,503,538 B1.

This aspect of the embodiment is also supported by experiments and conclusions set forth in Guo, K., et al., Journal of Polymer Science, Part A: Polymer Chemistry 43(7), 1463-1477 (15 Feb. 2005), the whole of which is incorporated herein by reference.

UPEA is functionalized by reacting a thiol-based compound with the polymers. The thiol-based compounds contain a thiol group and a functional group. In one facet of this embodiment, the thiol-based compound is selected from the group consisting of 3-mercaptopropionic acid, cysteamine, 2-mercaptoethanol, sodium-3 mercapto 1-propane-sulfonate, and 2-aminoethanethiol hydrochloride. In yet another facet, the functional group is selected from the group consisting of NH₂, NH₂HCl, COOH, a sulfonic group and OH. The thiol group of the thiol-based compound attaches via a carbon to carbon double bond within the UPEA, resulting in a free pendant functional group along the backbone of the polymers, respectively.

UPEA is mixed with a thiol-based compound and an organic solvent such as DMA, DMSO, DMF, or combinations thereof to form a mixture. The mixture is heated to produce the desired polymer. The mixture is preferably heated at a temperature of 50° C. to 120° C., preferably 60° C. to 80° C., and more preferably 70° C. for a time of 12-36 hours, and preferably 24 hours.

In another aspect of this embodiment, an initiator is used in the reaction. For example, a thiol-ene reaction is a reaction, which can proceed in the presence of a radical initiator such as Azobisisobutyronitrile (AIBN), between a thiol moiety and an unconjugated C═C double bond to form a thioether. The UPEA (or UPEEA) polymers have double bonds along the polymer backbone available for radical addition of various thiols to provide a variety of different pendant functional groups, which could be used as the active covalent attaching sites for biologically active agents or drugs. For example, radical addition of thiols to the double bonds of a compound is carried out at 50-100° C. using AIBN as a radical initiator in DMF.

The reaction results in UPEA substituted with a side chain selected from the group consisting of (2 carboxyethyl)thio, (2-hydroxethyl)thio, (2-aminoethyl)thio, and (2-aminoethyl)thio hydrochloride salt produced based polymer is obtained.

In yet another facet of this embodiment, the polymer of formula (I) is UPEEA substituted with a side chain selected from the group consisting of (2-carboxyethyl)thio, (2-hydroxethyl)thio, (2-aminoethyl)thio, and (2-aminoethyl)thio hydrochloride.

UPEEAs are prepared by solution polycondensation of either (1) di-p-toluene sulfonic acid salt of bis(a-amino acid) di-ester of unsaturated diol and di-p-nitrophenyl ester of saturated dicarboxylic acid, (2) di-p-toluene sulfonic acid salt of bis(α-amino acid) diester of saturated diol and di-nitrophenyl ester of unsaturated dicarboxylic acid, or (3) di-p-toluene sulfonic acid salt of bis(α-amino acid) diester of unsaturated diol and di-nitrophenyl ester of unsaturated dicarboxylic acid.

Di-p-nitrophenyl esters of saturated dicarboxylic acid and di-p-toluenesulfonic acid salts of bis(alpha-amino acid) diesters of saturated diol can be prepared as discussed above and in U.S. Pat. No. 6,503,538 B1

Di-p-nitrophenyl esters of saturated dicarboxylic acid and di-p-toluenesulfonic acid salts of bis(alpha-amino acid) diesters of saturated diol can be prepared as described above for UPEA in U.S. Pat. No. 6,503,538 B1.

Di-p-toluenesulfonic acid salt of bis(alpha-amino acid) diesters of unsaturated diol and di-nitrophenyl ester of unsaturated dicarboxylic acid can also be prepared as described above for UPEA and in U.S. Pat. No. 6,503,538 B1.

In one aspect of this embodiment, di-p-nitrophenylester of unsaturated dicarboxylic acid is reacted with a di-p-toluenesulfonic acid salt of bis-amino acid ester from oligoethylene glycol (V) and amino acid (IV). The reaction for producing di-p-toluenesulfonic acid salt of bis-amino acid ester from oligoethylene glycol (V) and an amino acid (IV) is exemplified in scheme I:

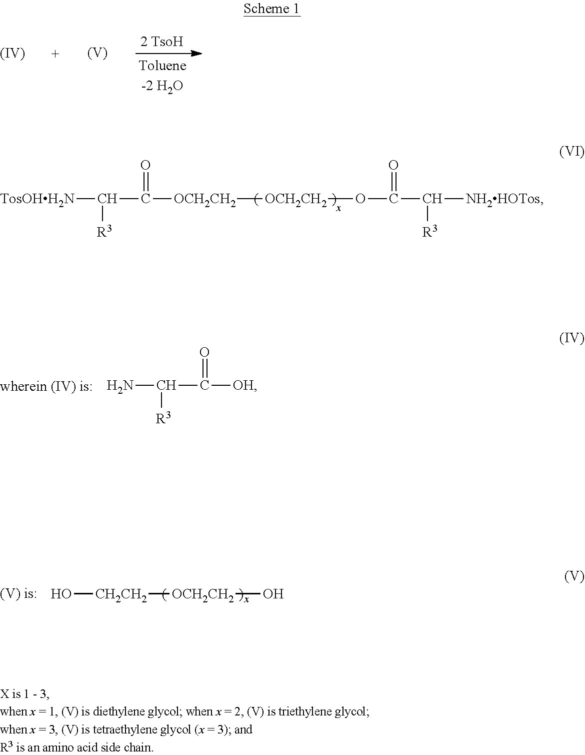

In other aspects of this embodiment, alanine, glycine, isoleucine, leucine, and valine can be substituted for the compound of formula (IV).

The compound of formula (VI) is preferably reacted with ET₃N, TosOH and 4-nitrophenol in a solvent such as DMA to produce UPEEA. The reaction is exemplified as follows:

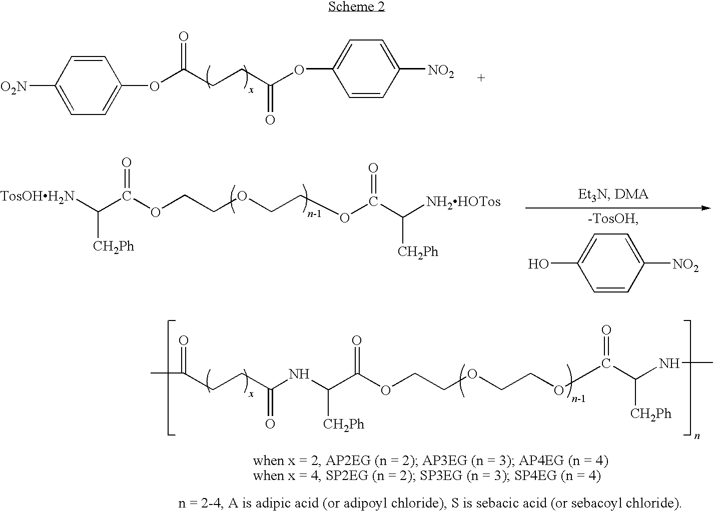

Synthesis of UPEEAs is also explained in Guo et al., Journal of Applied Polymer Science, Vol. 110, 1858-1869 (2008), Guo et al., Biomacromolecules, 8, 2851-2861 (2007), and U.S. Pat. Nos. 5,516,881; 6,476,204; and 6,503,538.

UPEEA is functionalized in a manner similar to UPEA discussed above.

A second embodiment of the invention is a polymer having the structural formula:

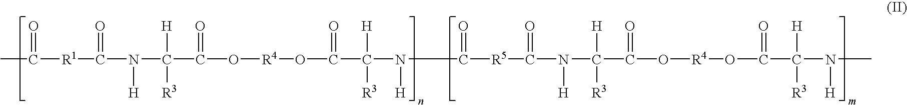

wherein R¹ is (C₂-C₂₈)alkylene; (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt;

R³ is selected from the group consisting of hydrogen, (C₁-C₆)alkyl, and (C₆-C₁₀)aryl;

R⁴ is selected from the group consisting of (C₂-C₂₈)alkyloxy, (C₂-C₂₈)alkylene, (C₂-C₂₈)alkyloxy substituted with a side chain selected from the group consisting of (2-carboxyethyl)thio, (2-hydroxethyl)thio, (2-aminoethyl)thio and (2-aminoethyl)thio hydrochloride salt, and —C₂H₄(OC₂H₄)ₓ, or (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt, and —C₂H₄(OC₂H₄)ₓ;

R⁵ is (C₂-C₂₀)alkylene;

n ranges from 0.9 to 0.1;

m ranges from 0.1 to 0.9; and

wherein at least one of R1 and R4 attaches a functional group.

Synthesis of the polymers of formula (II) generally involve three general steps: (1) synthesis of di-p-nitrophenyl esters of dicarboxylic acids (e.g., bis-p-nitrophenyl succinate (NSu, Ia), bis-p-nitrophenyl adipate (NA), bis-p-nitrophenyl sebacate (NS), and/or bis-p-nitrophenyl fumarate (NF)), which serve as diester monomers; (2) synthesis of di-p-toluenesulfonic acid salts of bis-L-amino acid esters from triethylene glycol (P3EG), which serve as a diamide monomers; and (3) solution polycondensation of the above-identified monomers (e.g., see Guo et al., Copolymers, Vol. 110, 1858-1869 (2008), Guo et al., Biomacromolecules, 8, 2851-2861 (2007), and U.S. Pat. Nos. 5,516,881; 6,476,204; and 6,503,538).

A compound of formula (II) can be made in similar fashion to the compound (VII) of U.S. Pat. No. 6,503,538 except that R₄ of (III) of U.S. Pat. No. 6,503,538 and/or R₁ of (V) of U.S. Pat. No. 6,503,538 is C₂-C₂₀ alkenylene as described above. The reaction is carried out, for example, by adding dry triethylamine to a mixture of (III) and (IV) of U.S. Pat. No. 6,503,538 and (V) where at least one of (III) and (V) contains C₂-C₂₀ alkenylene in dry N,N-dimethylacetamide, at room temperature, then increasing the temperature to 80° C. and stirring for 16 hours, then cooling the reaction solution to room temperature, diluting with ethanol, pouring into water, separating polymer, washing separated polymer with water, drying to about 30C under reduced pressure and then purifying up to negative test on p-nitrophenol and p-toluenesulfonate. A preferred reactant (IV) is p-toluenesulfonic acid salt of L-lysine benzyl ester. When the reactant (IV) is p-toluenesulfonic acid salt of benzyl ester, the benzyl ester protecting group is preferably removed from to confer biodegradability, but it should not be removed by hydrogenolysis as in Example 22 of U.S. Pat. No. 6,503,538 because hydrogenolysis would saturate the desired double bonds; rather the benzyl ester group should be converted to an acid group by a method which would preserve unsaturation, e.g., by treatment with fluoroacetic acid or gaseous HF. Alternatively, the lysine reactant (IV) can be protected by protecting group different from benzyl which can be readily removed in the finished product while preserving unsaturation, e.g., the lysine reactant can be protected with t-butyl (i.e., the reactant can be t-butyl ester of lysine) and the t-butyl can be converted to H while preserving unsaturation by treatment of the product (II) with dilute acid.

For the cases where R⁴ is ((CH₂)ᵣO)_{q}—(C₂-C₂₀)alkylene, di-p-toluenesulfonic acid salt of bis(alpha-amino acid) diester of lower oligomer of ethylene glycol is used in place of di-p-toluenesulfonic acid salt of bi(alpha-amino acid) diester of saturated diol and can be prepared by substituting lower oligomer of ethylene glycol (e.g., diethylene glycol, triethylene glycol, tetraethylene glycol or pentaethylene glycol) in place of diol in the synthesis of III described in U.S. Pat. No. 6,503,538 B1.

A third embodiment is a composition comprising a polymer of the first or second embodiment. In order to form a composition, the functional group(s) on the polymers are substituted, directly or indirectly with a linker, with a bioactive and/or active material. When the polymer has pendant —COOH or —OH groups, the —COOH and —OH groups are substituted with a positively charged active material. When the polymer has a free pendent —NH₂ or —NH₂HCl groups, the NH₂ or NH₂HCl groups are substituted with negatively charged active materials.

The bioactive and/or active material is selected from the group consisting of a peptide, antibiotic, drug, polypeptide, anti-inflammatory agent, anti-platelet agent, anti-coagulation agent, immuno-suppressive agents, nitric oxide derivative, antimicrobial agents, growth factors, polymers, fluorescent compounds (e.g., fluorescein), hydrogel forming polymers, gel forming polymers, and combinations thereof.

As used herein, a “peptide” is a sequence of 2 to 25 amino acids (e.g. as defined hereinabove) or peptidic residues having one or more open valences. The sequence may be linear or cyclic. For example, a cyclic peptide can be prepared or may result from the formation of disulfide bridges between two cysteine residues in a sequence. A peptide can be linked through the carboxy terminus, the amino terminus, or through any other convenient point of attachment, for example, through the sulfur of a cysteine. Peptide derivatives can be prepared as disclosed in U.S. Pat. Nos. 4,612,302; 4,853,371; and 4,684,620. Peptide sequences specifically recited herein are written with the amino terminus on the left and the carboxy terminus on the right. A preferred peptide is GRGD.

One or more of an antibiotic and/or drug can be directly or indirectly linked to the functional group of the polymer. Suitable antibiotics include β-lactam antibiotics (e.g., penicillin derivatives, cephalosporins, monobactams, carbapenems, and β-lactamase inhibitors), Adriamycin PFS/RDF® (Pharmacia & Upjohn), Blenoxane® (Bristol-Myers Squibb Oncology/Immunology), Cerubidine® (Bedford), Cosmegen® (Merck), DaunoXome® (NeXstar), Doxil® (Sequus), Doxorubicin Hydrochloride® (Astra), Idamycin® PFS Pharmacia & Upjohn), Mithracin® (Bayer), Mitamycin® (Bristol-Myers Squibb Oncology/Immunology), Nipen® (SuperGen), Novantrone® (Immunex) and Rubex® (Bristol-Myers Squibb Oncology/Immunology). Suitable antimetabolites include Cytostar-U® (Pharmacia & Upjohn), Fludara® (Berlex), Sterile FUDR® (Roche Laboratories), Leustatin® (Ortho Biotech), Methotrexate® (Immunex), Parinethol® (Glaxo Wellcome), Thioguanine® (Glaxo Wellcome) and Xeloda® (Roche Laboratories).

A drug is a therapeutic agent or a diagnostic agent and includes any substance, other than food, used in the prevention, diagnosis, alleviation, treatment, or cure of a disease. Stedman's Medical Dictionary 25 th Edition, Illustrated (1990) p. 486. The substance can be taken by mouth; injected into a muscle, the skin, a blood vessel, or a cavity of the body; or topically applied. Mosby's Medical, Nursing & Allied Health Dictionary, Fifth Edition, (1998) p. 516. The drug can include any substance disclosed in at least one of: The Merck Index, 12 th Edition (1996); Concise Dictionary of Biomedicine and Molecular Biology. Pei-Show Juo, (1996); U.S. Pharmacopeia Dictionary 2000 Edition; and Physician's Desk Reference, 2001 Edition. Specifically, the drug can include, but is not limited to, one or more: polypeptides, therapeutic antibodies abeiximab, anti-inflammatory agents, blood modifiers, anti-platelet agents, anti-coagulation agents, immune suppressive agents, anti-cell proliferation agents, and nitric oxide releasing agents. In one facet of this embodiment, the antibiotic and/or drug is a β-lactam compound such as a penicillin (e.g., penicillin V, penicillin G, procaine benzylpenicillin, or benzathine pencillin). Penicillin sodium salts and penicillin are attached in one embodiment and are exemplified as follows:

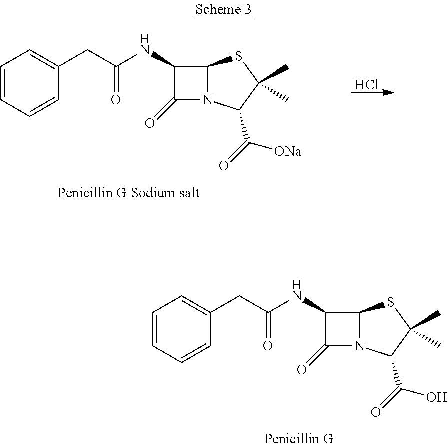

Polypeptides can have any suitable length. Specifically, the polypeptides can be about 2 to about 5,000 amino acids in length, inclusive; about 2 to about 2,000 amino acids in length, inclusive; about 2 to about 1,000 amino acids in length, inclusive; or about 2 to about 100 amino acids in length, inclusive.

The polypeptides can also include “Peptide mimetics”. Peptide analogs are commonly used in the pharmaceutical industry as non-peptide drugs with properties analogous to those of the template peptide. These types of non-peptide compound are termed “peptide mimetics”. Fauchere, J. (1986) Adv. Drug Res. 15:29; Veber and Freidinger (1985) TINS p. 392; and Evans et al. (1987) J. Med. Chem., 30: 1229; and are usually developed with the aid of computerized molecular modeling.

Generally, peptidomimetics are structurally similar to a paradigm polypeptide (i.e., a polypeptide that has a biochemical property or pharmacological activity), but have one or more peptide linkages optionally replaced by a linkage selected from the group consisting of: —CH₂NH—, —CH₂CH₂—, —CH═H— (cis and trans), —COCH₂—CH(OH)CH₂—, and —CH₂SO—, by methods known in the art and further described in the following references: Spatola, A. F. in “Chemistry and Biochemistry of Amino Acids, Peptides, and Proteins,” B. Weinstein, eds., Marcel Dekker, New York, p. 267 (1983); Spatola, A F., Vega Data (March 1983), Vol. 1, Issue 3, “Peptide Backbone Modifications” (general review); Morley, J. S., Trends. Pharm. Sci., (1980) pp. 463-468 (general review); Hudson, D. et al., Int J. Pept. Prot. Res., (1979) 14:177-185 (—CH₂NH—, CH₂CH₂—); Spatola, A. F. et al., Life Sci. (1986) 38:1243-1249 (—CH₂—S—); Hann, M. M., J. Chem. Soc. Perkin Trans I (1982) 307-314 (—CH═CH—, cis and trans); Almquist, R. G. et al., J. Med. Chem., (1980) 23:1392-1398 (—COCH₂—); Jennings-White, C. et al., Tetrahedron Lett., (1982) 23:2533 (—COCH₂—) Szelke, M. et al., Europolymem Appin., EP 45665 (1982) CA: 97:39405 (1982) (—CH(OH)CH₂—); Holladay, M. W. et al., Tetrahedron Lett., (1983) 24:4401-4404 (—C(OH)CH₂—); and Hruby, V. J., Life Sci., (1982) 31:189-199 (—CH₂—S—).

Such peptide mimetics may have significant advantages over polypeptide embodiments, including, for example: more economical production, greater chemical stability, enhanced pharmacological properties (half-life, absorption, potency, efficacy, etc.), altered specificity (e.g., a broad-spectrum of biological activities), reduced antigenicity, and others.

Additionally, substitution of one or more amino acids within a polypeptide with a D-amino acid of the same type (e.g., D-lysine in place of L-lysine) can be used to generate more stable polypeptides and polypeptides resistant to endogenous proteases.

In one aspect, the polypeptide can be an antibody. Examples of such antibodies include single-chain antibodies, chimeric antibodies, monoclonal antibodies, polyclonal antibodies, antibody fragments, Fab fragments, IgA, IgG, IgM IgD, IgE and humanized antibodies. In one embodiment, the antibody can bind to a cell adhesion molecule, such as a cadherin, integrin or selectin. In another case, the antibody can bind to a molecule, such as collagen, elastin, fibronectin or laminin.

In yet another facet of this embodiment, the antibody can bind to a receptor, such as an adrenergic receptor, B-cell receptor, complement receptor, cholinergic receptor, estrogen receptor, insulin receptor, low-density lipoprotein receptor, growth factor receptor or T-cell receptor. Antibodies of the invention can also bind to platelet aggregation factors (e.g., fibrinogen), cell proliferation factors (e.g., growth factors and cytokines), and blood clotting factors (e.g., fibrinogen).

In another case, an antibody can be conjugated to an active agent, such as a toxin. For example, the antibody can be Abciximab (ReoPro(R)). Abeiximab is an Fab fragment of a chimeric antibody that binds to beta(3) integrins. Abciximab is specific for platelet glycoprotein IIb/IIIa receptors, e.g., on blood cells. Human aortic smooth muscle cells express alpha(v)beta(3) integrins on their surface. Treating beta(3) expressing smooth muscle cells may prohibit adhesion of other cells and decrease cellular migration or proliferation, thus reducing restinosis following percutaneous coronary interventions (CPI) e.g., stenosis, angioplasty, stenting. Abciximab also inhibits aggregation of blood platelets.

In one case, the peptide can be a glycopeptide. “Glycopeptide” refers to oligopeptide (e.g. heptapeptide) antibiotics, characterized by a multi-ring peptide core optionally substituted with saccharide groups, such as vancomycin. Examples of glycopeptides included in this definition may be found in “Glycopeptides Classification, Occurrence, and Discovery”, by Raymond C. Rao and Louise W. Crandall, (“Drugs and the Pharmaceutical Sciences” Volume 63, edited by Ramakrishnan Nagarajan, published by Marcal Dekker, Inc.). Additional examples of glycopeptides are disclosed in U.S. Pat. Nos. 4,639,433; 4,643,987; 4,497,802; 4,698,327; 5,591,714; 5,840,684; and 5,843,889; in EP 0 802 199; EP 0 801 075; EP 0 667 353; WO 97/28812; WO 97/38702; WO 98/52589; WO 98/52592; and in J. Amer. Chem. Soc., 1996, 118, 13107-13108; J. Amer. Chem. Soc., 1997, 119, 12041-12047; and J. Amer. Chem. Soc., 1994, 116,4573-4590. Representative glycopeptides include those identified as A477, A35512, A40926, A41030, A42867, A47934, A80407, A82846, A83850 A84575, AB65, Actaplanin, Actinoidin, Ardacin, Avoparcin, Azureomycin, Balhimycin, Chloroorientiein, Chloropolysporin, Decaplanin, -demethylvancomycin, Bremomycin, Galacardin, Helvecardin, Izupeptin, Kibdelin, LL-AM374, Mannopeptin, MM45289, MM47756, MM47761, MM49721, MM47766, MM55260, MM55266, MM55270, MM56597, MMS6598, OA-7653, Orenticin, Parvodicin, Ristocetin, Ristomycin, Synmonicin, Teicoplanin, UK-68597, UK-69542, UK-72051, Vancomycin, and the like. The term “glycopeptide” or “glycopeptide antibiotic” as used herein is also intended to include the general class of glycopeptides disclosed above on which the sugar moiety is absent, i.e. the aglycone series of glycopeptides. For example, removal of the disaccharide moiety appended to the phenol on vancomycin by mild hydrolysis gives vancomycin aglycone. Also included within the scope of the term “glycopeptide antibiotics” are synthetic derivatives of the general class of glycopeptides disclosed above, included alkylated and acylated derivatives. Additionally, within the scope of this term are glycopeptides that have been further appended with additional saccharide residues, especially aminoglycosides, in a manner similar to vancosamine.

In one facet, the peptide is a lipidated glycopeptide. The term “lipidated glycopeptide” refers specifically to those glycopeptide antibiotics which have been—synthetically modified to contain a lipid substituent. As used herein, the term “lipid substituent” refers to any substituent containing 5 or more carbon atoms, preferably, 10 to 40 carbon atoms. The lipid substituent may optionally contain from 1 to 6 heteroatoms selected from halo, oxygen, nitrogen, sulfur and phosphorous. Lipidated glycopeptide antibiotics are well-known in the art. See, for example, in U.S. Pat. Nos. 5,840,684, 5,843,889, 5,916,873, 5,919,756, 5,952,310, 5,977,062, 5,977,063, EP 667,353, WO 98/52589, WO 99/56760, WO 00/04044, WO 00/39156, the disclosures of which are incorporated herein by reference in their entirety.

Anti-inflammatory agents include, e.g., analgesics (e.g., NSAIDS and salicylates), antirheumatic agents, gastrointestinal agents, gout preparations, hormones (glucocorticoids), nasal preparations, ophthalmic preparations, otic preparations (e.g., antibiotic and steroid combinations), respiratory agents, and skin & mucous membrane agents. See, Physician's Desk Reference, 2001 Edition. Specifically, the anti-inflammatory agent can include dexamethasone, which is chemically designated as (11β,16α)-9-fluoro-11,17,21-trihydroxy-16-methylpregna-1,4diene- 3,20-dione. Alternatively, the anti-inflammatory agent can include sirolimus (rapamycin), which is a triene macrolide antibiotic isolated from Streptomyces hygroscopicus.

Anti-platelet and anticoagulation agents include, e.g., Coumadin® (DuPont), Fragmin® (Pharmacia & Upjohn), Heparin® (Wyeth-Ayerst), Lovenox®, Normiflo®, Orgaran® (Organon), Aggrastat® (Merck), Agrylin® (Roberts), Ecotrin® (Smithkline Beechamn), Flolan® (Glaxo Wellcome), Halfprin® (Kramer), Integrillin® (COR Therapeutics), Integrillin® (Key), Persantine® (Boehringer Ingelheim), Plavix® (Bristol-Myers Squibb), ReoPro® (Centecor), Ticlid® (Roche), Abbokinase® (Abbtt), Activase® (Genentech), Eminase® (Roberts), and Strepase® (Astra). See, Physician's Desk Reference, 2001 Edition. Specifically, the anti-platelet and anti-coagulation agent can include trapidil (avantrin), cilostazol, heparin, hirudin, or ilprost.

Trapidil is chemically designated as N,N-dimethyl-5-methyl-[1,2,4]triazolo[1,-5-a]pyrimidin4-amine. Cilostazol is chemically designated as 6-[4-(1-cyclohexyl-1H-tetrazol-5-yl)-butoxy]-3,4-dihydro-2(1H)-quinolinone.

Heparin is a glycosaminoglycan with anticoagulant activity; a heterogeneous mixture of variably sulfonated polysaccharide chains composed of repolymerting units of D-glucosamine and either L-iduronic or D-glucuronic acids. Hirudin is an anticoagulant protein extracted from leeches, e.g., Hirudo medicinalis. Iloprost is chemically designated as 5-[Hexahydro-5-hydroxy-4-(3-hydroxy-4-methyl-1-octen-6-ynyl)-2(1H)-pentalenylidene]pentanoic acid.

The immune suppressive agent can include, e.g., Azathioprine® (Roxane), BayRho-D® (Bayer Biological), CellCept® (Roche Laboratories), Imuran® (Glaxo Wellcome), MiCRhoGAM® (Ortho-Clinical Diagnostics), Neoran® (Novarts), Orthoclone OKT3® (Ortho Biotech), Prograf® (Fujisawa), PhoGAM® (Ortho-Clinical Diagnostics), Sandimmune® (Novartis), Simulect® (Novartis), and Zenapax® (Roche Laboratories). Specifically, the immune suppressive agent can include rapamycin or thalidomide. Rapamycin is a triene macrolide isolated from Streptomyces hygroscopicus.

In one case, a therapeutically effective amount of the nitric oxide (NO) derivative compound binds to the functionalized acid of the polymer. Examples of such compounds are 2,2,5,5-tetramethylpyrrolidine-1-oxy; 2,2,5,5-tetramethyl-3-pyrroline-1-oxy-3-carbonyl; 4-(N,N-dimethyl-N-hexadecyl)ammonium-2,2,6,6-tetramethylpiperidine-1-oxy, iodide (CAT16); 4-trimethylammonium-2,2,6,6-tetramethylpiperidine-1-oxy, iodide (CAT 1); 3-amino-2,2,5,5-tetramethylpyrrolidine-1-oxy; N-(3-(iodoacetyl)amino)-2,2,5,5-tetramethylpyrrolidine-1-oxy(PROXYL 1A); succinimidyl 2,2,5,5-tetramethyl-3-pyrroline-1-oxy-3-carboxylate; 2,2,5,5-tetramethyl-3-pyrroline-1-oxy-3-carboxylic acid; 2,2,6,6-tetramethylpiperidine-1-oxy; 4-amino-2,2,6,6-tetramethylpiperadine-1-oxy; 4-carboxy-2,2,6,6-tetramethylpiperadine-1-oxy;4-acetamido-2,2,6,6-tetramethylpiperadine-1-oxy; 4-bromo-2,2,6,6-tetramethylpiperadine-1-oxy; 4-(N,N-dimethyl-N-(2-hydroxyethyl)ammonium-2,2,6,6-tetramethylpiperidine-1-oxy; 4-(N,N-dimethyl-N-(3-sulfopropyl)ammonium-2,2,6,6-tetramethylpiperidine-1-oxy; N-(4-(iodoacetyl)amino-2,2,6,6 tetramethylpiperidine-1-oxy; N-(2,2,6,6-tetramethylpiperidine-1-oxy-4-yl)maleimide; and mixtures thereof. A particularly preferred compound is 4-amino-2,2,6,6-tetramethylpiperadine-1-oxy radical.

A niticoxide like compound can also be incorporated into the polymer. Suitable niticoxide like compounds are disclosed, e.g., in U.S. Pat. No. 5,650,447. See also, e.g., Inhibition of neointimal proliferation in rabbits after vascular injury by a single treatment with a protein adduct of nitric oxide, David Marks et al J. Clin. Invest. (1995);96:2630-2638.

An antimicrobial is a substance that kills or inhibits the growth of microbes such as bacteria, fungi, protozoals or viruses. The antimicrobial can be anti-viral, anti-bacterial, anti-fungal agent, or metal (e.g., Ag, Cu, or Hg). In a preferred aspect, the antimicrobial is not attached to the polymer. Rather, the antimicrobial is immersed within and around the polymer. In yet another embodiment, silver is a preferred antimicrobial.

The term growth factor refers to a naturally occurring protein capable of stimulating cellular growth, proliferation and cellular differentiation. Growth factors are important for regulating a variety of cellular processes. Growth factors typically act as signaling molecules between cells. Examples are cytokines and hormones that bind to specific receptors on the surface of their target cells. They often promote cell differentiation and maturation, which varies between growth factors. For example, bone morphogenic proteins stimulate bone cell differentiation, while fibroblast growth factors and vascular endothelial growth factors stimulate blood vessel differentiation (angiogenesis). Examples of growth factors that can be used in accordance with the claimed invention include but are not limited to Endothelial growth factor (EGF), Erythropoietin (EPO), Fibroblast growth factor (FGF), Granulocyte-colony stimulating factor (G-CSF), Granulocyte-macrophage colony stimulating factor (GM-CSF), Growth differentiation factor-9 (GDF9), Hepatocyte growth factor (HGF), Insulin-like growth factor (IGF), Myostatin (GDF-8), Nerve growth factor (NGF), Platelet-derived growth factor (PDGF), Thrombopoietin (TPO), Transforming growth factor alpha(TGF-α), Transforming growth factor beta (TGF-β), Vascular endothelial growth factor (VEGF).

The polymer of compound I can also be reacted with other polymers. For example, when the polymer have pendant hydroxyl group, the functional groups can act as an alcohol and serve as the starting reactive site to chemically attach a synthetic absorbable aliphatic polyester macromolecule like poly-ε-caprolactone (PCL) or/and polylactide (PLA) (i.e., a polymer backbone with PCL or/and PLA grafted side chains).

In addition to being attached to or linked to one or more active materials, either directly or through a linker, polymers of the present invention can be physically intermixed with one or more bioactive materials. As used herein, “intermixed” refers to a polymer of the present invention physically mixed with a bioactive and/or active material or a polymer of the present invention physically in contact with a bioactive and/or active material.

Any suitable amount of polymers and bioactive material can be employed to provide a composition. The polymers can be present in about 0.1 wt % to about 99.9 wt. % of the composition. Typically, the polymer can be present above about 25 wt % of the composition; above about 50 wt % of the composition; above about 75 wt % of the composition; or above about 90 wt % of the composition.

A feature of this embodiment is reacting polymer with a polysaccharide, such as dextran, hyaluronic acid, chitosan, alginate, inulin, starch, cellulose, pullan, levan, mannan, chitin, xylan, pectin, glucuronan, laminarin, galactomannan, amylose, amylopectin, phytophtoorglucans, or ethylcellulose. Polysaccharides such as dextran, inulin, starch, cellulose, pullan, levan, mannan, chitin, xylan, pectin, glucuronan, laminarin, galactomannan, amylose, amylopectin, and phytophtoorglucans provide a hydroxy pendant functional group.

The polymer of the first embodiment can be reacted with the polysaccharide via a compound such as carbonyldiimidazole, which facilitates the reaction of NH₂ and COOH groups. For example, polymer compounds having a free NH₂ pendant functional group can be reacted with a polysaccharide such a hyaluronic acid. Hyaluronic acid is a negatively charged polysaccharide and is as shown as follows:

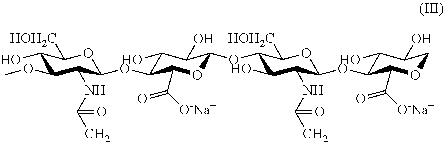

In yet another facet of this embodiment, a gel is produced. Gels of this embodiment can be produced by several different methods.

In a first method for producing a gel, a polymer compound of formula I or II with free amine groups can be used to make gels via an amine-reactive bifunctional cross-linker. An amine-reactive bifunctional crosslinker (e.g., glutaraldehyde) is reacted with the polymer to form a gel. In addition to glutaraldehyde, dimethyl adipimidate (DMA), dimethyl suberimidate (DMS), dimethyl pimelimidate (DMP), N-hydroxysuccinimide (NHS) esters, dithiobis(succinimidylpropionate), and dithiobis(sulfosuccinimidylpropionate) DTSSP can be used.

In a second method for producing a gel, carbonyldiimidazole is used to facilitate the reaction of a free NH₂ pendant functional group with a free COOH functional group to form a gel. A polymer compound of formula I or II having a free pendant functional group of NH₂, or COOH is reacted with carbonyldiimidazole and a compound having a corresponding NH₂ or COOH functional group. For example, a polymer compound having a free amine group can be reacted with polymer having carboxylic group via carbonyldiimidazole to form a transparent gel.

In a yet another facet of this embodiment, a hydrogel can be produced. For example, in a method for producing a hydrogel, a photoinitiator is added to a dimethyl sulfoxide solution of polymer of formula I or II and PEG-DA with molecular weight 700. The weight ratio of polymer precursor to PEG-DA is from 0.1-0.3:1 and preferably is 0.2:1

Any photoinitiator can be used, but the photoinitiator is preferably 2,2-dimethoxy 2-phenyl acetophenone, 4-(2-hydroxyethoxy)phenyl-(2-hydroxy-2-propyl)ketone (Irgacure 2959) and DMPAP. The photoinitiator is preferably added in an amount of 0.01-10%, 0.1-3.0% (w/w). A solvent is optionally added depending on the type of photoinitiator used (e.g., DMPAP). The solvent solvent, e.g., N-methylpyrrolidone, tetrahydrofuran, dimethyl formamide or dimethyl sulfoxide, is added to the solution.

Photocrosslinking is carried out by UV irradiation, e.g., at room temperature, preferably 20° C. to 30° C., for 5 to 30 minutes, preferably 10 to 20 minutes. Unreacted chemicals are then preferably leached out of the resulting gel.

The hydrogels or gels produced with the polymers are useful for a variety of purposes including the controlled release of bioactive and/or active materials. In this aspect, the bioactive and/or active materials may be reacted with the free functional groups in the polymers to form covalent bonds between the bioactive and/or active materials and a precursor, and/or physically encapsulated or entrapped by the precursor. The bioactive and/or active material is released by metabolic action on the hydrogel, and the attachment to or entrapment in or encapsulation with hydrogel delays release, for example, for 2 to 48 hours or more.

The hydrogels or gels from the polymers herein are also useful as a temporary skin cover, e.g., as a wound dressing or artificial skin. In this case, the hydrogel or gel can advantageously incorporate antimicrobial agent and/or would healing growth factor(s) as discussed above.

The hydrogels or gels produced from the polymers herein can also encapsulate viruses used in gene therapy to protect the viruses from the body's immune system until they reach the site where the genetic alteration is to occur. In conventional gene therapy, viruses are injected at the site of prospective incorporation and many injections are required to accommodate for inactivation of viruses. The hydrogels herein protect the viruses so that fewer injections may be utilized.

The hydrogels from the polymers herein can also be useful for agricultural purposes to coat seeds. The hydrogel coating promotes retention of water during seed germination and promotes oxygen transport via pore structures and may include chemical agents, e.g., pesticides, for delivery to the seeds.

The hydrogels from polymer herein are useful for the administration of basic fibroblast growth factor (bFGF) to stimulate the proliferation of osteoblasts (i.e., promote bone formation) and to stimulate angiogenesis (development of blood vessels). The pendant free carboxylic acid groups in the precursors herein serve as sites for the ionic bonding of bFGF. The hydrogels incorporating bFGF are applied to bone or blood vessels locally. Upon the biodegradation of the hydrogel, sustained release of bFGF for promoting bone growth and blood vessel formation is obtained. The bonding of the bFGF to the precursors herein protects the bFGF against enzymatic degradation or denaturing so the bFGF can perform its biological functions and occurs because of the bFGF's inherent affinity toward acid compounds.

The hydrogels from the polymers herein can be useful for integral components in microdevices, for example, biosensors. The functional group in the hydrogel is very sensitive to various environmental stimuli, for example, pH and metal ions concentration, the swelling ratio and other properties of the hydrogel can accordingly change based on the change of controlled external stimuli.

The hydrogels from the polymers herein are also useful in the cases where hydrogels are conventionally used, e.g., for thickening in foods, for moisture release to plants, for fluid uptake and retention in the sanitary area, as hydrophilic coatings for textile applications, for contact lenses and for separation and diffusion gel in chromatography and electrophoresis.

The drugs, bioactive and/or active material in one facet of this embodiment are not reactive with components of the hydrogel-forming system herein and can be physically entrapped within the hydrogel or physically encapsulated within the hydrogel by including them in the reaction mixture subjected to photocrosslinking so that the photocrosslinking causes formation of hydrogel with bioactive and/or active material entrapped therein or encapsulated thereby.

The foregoing description of the invention has been presented describing certain operable and preferred embodiments. It is not intended that the invention should be so limited since variations and modifications thereof will be obvious to those skilled in the art, all of which are within the spirit and scope of the invention.

Working examples for the invention are set forth below.

The invention is illustrated by the following working examples:

### Background Example I

In this example, the synthesis and characterization of a series of biodegradable UPEAs of the first embodiment of the invention by the solution polycondensation of two unsaturated monomers, di-p-nitrophenyl fumarate (NF) and p-toluenesulfonic acid salt of bis(L-phenylalanine)2-butene-1,4-diester (PBe), and four saturated monomers, namely p-toluenesulfonic acid salt of bis(L-phenylalanine)butane-1,4-diester (PB), p-toluenesulfonic acid salt of bis(L-phenylalanine) hexane-1,6-diester (PH), di-p-nitrophenyl adipate (NA), and di-p-nitrophenyl sebacate (NS), are described. The effects of reaction time, temperature, and different solvents on the molecular weights and molecular weight distributions (MWDs) of the resultant polymers are considered.

NA and NS were prepared through the reaction of the corresponding dicarboxylic acyl chlorides with p-nitrophenol as described in Katsarava, R., et al., J. Polym. Sci., Part A: Polym. Chem. 37, 391-407 (1999).

NF was synthesized from p-nitrophenol and fumaryl chloride (FC) according to a modification of conditions used for synthesis of NA and NS, as follows: A solution of triethylamine (0.0603 mol) and p-nitrophenol (0.0603 mol) in 100 mL of acetone was prepared at room temperature, and this solution was kept at −78° C. with dry ice and acetone. FC (0.03 mol, 3.2 mL) in 40 mL of acetone was then added to the chilled solution dropwise with stirring for 2 h at −78° C. and then with stirring at room temperature overnight. After that, the mixture was poured into 800 mL of distilled water to precipitate the product, NF, which was filtered, washed thoroughly with distilled water, dried in vacuo at 50° C., and finally purified by recrystallization from acetonitrile three times.

(PBe), (PB) and (PH) were prepared as follows: L-Phenylalanine (0.132 mol), p-toluenesulfonic acid monohydrate (0.132 mol), and diol (0.06 mol) in 250 mL of toluene were placed in a flask equipped with a Dean-Stark apparatus, a CaCl₂ drying tube, and a magnetic stirrer. The solid-liquid reaction mixture was heated to reflux for 16 h until 4.3 mL (0.24 mol) of water evolved. The reaction mixture was then cooled to room temperature, filtered and dried in vacuo, and finally purified by recrystallization three times. According to the type of di-p-toluenesulfonic acid salt of bis(L-phenylalanine) diester synthesized, different solvents were used for recrystallization. For example, water and n-butanol were used as recrystallization media for the di-p-toluenesulfonic acid salt of bis(L-phenylalanine) butane-1,4-diester (PB) and di-p-toluenesulfonic acid salt of bis (L-phenylalanine) 2-butene-1,4-diester (PBe), respectively. Water was used as the recrystallization medium for (PH).

Five different UPEAs were prepared, two by solution polycondensation of NF with PB and NF with PH and two by solution polymerization of PBe with NA and PBe with NS and one by solution polymerization of NF and PBe. The combinations used are set forth in Table 1 below:

TABLE 1

| | Monomer Containing | |
|---|---|---|
| Monomer Combination | C═C | Obtained Polymer |
| NF + PB | NF | FPB |
| NF + PH | NF | FPH |
| NF + PBe | NF and PBe | FPBe |
| NS + PBe | PBe | SPBe |
| NA + PBe | PBe | APBe |

In the solution polycondensations, excess triethylamine was used as the acid receptor for p-toluenesulfonic acid during the polymerization to regenerate free amino groups in the di-p-toluenesulfonic acid salt monomer. Polymerization took place in a homogeneous phase, and the polymer obtained remained dissolved in the reaction solution, except that the reaction solution of FPH became a gel-like mixture after a certain time (longer at room temperature and shorter at a high temperature). The gel-like mixture that formed during FPH synthesis was proved to be not a real gel because it could dissolve in hexafluoroisopropanol and m-cresol, the latter being used as the solvent for viscosity measurements.

An example of the synthesis of APBe via solution polycondensation is given to illustrate the details of the synthesis procedures. Triethylamine (0.31 mL, 2.2 mmol) was added dropwise to a mixture of monomers NA (1.0 mmol) and PBe (1.0 mmol) in 1.5 mL of dry DMA, and the solution was heated to 60° C. with stirring until the complete dissolution of the monomers. The reaction vial was then kept under a specified temperature (25° C. or 70° C.) for predetermined durations (24, 48, 72, or 96 h) without stirring to determine the effects of the temperature and reaction duration on the polymerization reaction. The resulting solution was precipitated with cold ethyl acetate, filtered, extracted by ethyl acetate in a Soxhlet apparatus for 48 h, and finally dried in vacuo at 50° C.

Confirmation that APBe was formed having the structure

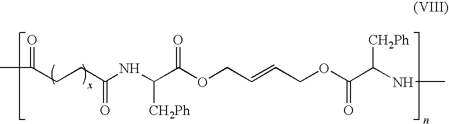

where x=2, was confirmed by FTIR and NMR spectral data.

The effects of type of solvent, reaction temperature and reaction solvent, on reduced viscosity and molecular weight of UPEAs were examined.

We turn now to the effect of different solvents on SPBe and FPB products formed. Three organic solvents were used, namely N-methyl pyrrolidone (NMP), N,N-dimethylformamide (DMF) and N,N-dimethylacetamide (DMA). In all three solvents, the reaction proceeded homogeneously. FPB would not dissolve in tetrahydrofuran (THF) or other normal organic solvents for molecular weight and MWD measurements so no data was observed for these for FPB. The results are set forth in Table 2 below:

TABLE 2

| | |
|---|---|
| | Molecular |
| Reduced | Weight |
| Viscosity | (kg/mol) |

| Sample | Solvent | (dL/g) | Mₙ | M_{w} | M_{w}/Mₙ |
|---|---|---|---|---|---|
| SPBe1 | NMP | 0.37 | 10.7 | 16.4 | 1.54 |
| SPBe2 | DMF | 0.48 | 17.5 | 25.1 | 1.43 |
| SPBe3 | DMA | 0.46 | 17.3 | 24.7 | 1.43 |
| FPB1 | NMP | 0.36 | — | — | — |
| FPB2 | DMF | 0.43 | — | — | — |
| FPB3 | DMA | 0.47 | — | — | — |

All the reactions were carried out at 70° C. for 48 h. The concentration of the reaction solution was 1.10 mol/L.

As shown in Table 2, SPBe obtained in DMF and SPBe obtained in DMA had a similar molecular weight and reduced viscosity value, which were much higher than those of SPBe synthesized in NMP. SPBe prepared in NMP also had a wider MWD than those prepared in DMF and DMA. FPB obtained in DMA had the highest reduced viscosity value of the FPB polymers synthesized in DMA, NMP and DMF. NMP was consequently not a good solvent for preparing high molecular weight UPEAs. When DMF was used as the solvent for FPB synthesis, the reaction solution became a gel-like mixture. This restricted chain propagation during polycondensation and led to the formation of polymers of relatively lower molecular weights. Such a less desirable reaction condition was improved when DMA was used as the solvent. Therefore, DMA was found to be the best solvent for the SPBe and FPB synthesis.

The effects of reaction temperature (25° C. or 70° C.) and reaction times (24, 48, 72, 96 h) determined at those temperatures on the molecular weight and reduced viscosity of SPBe products were determined. Results are set forth in Table 3 below:

TABLE 3

| 25° C. | | | | | 70° C. | | | |
|---|---|---|---|---|---|---|---|---|
| Reaction | Reduced | | | | Reduced | | | |
| Time | Viscosity | Mₙ | M_{w} | | Viscosity | Mₙ | M_{w} | |
| (h) | (dL/g) | (kg/mol) | (kg/mol) | M_{w}/Mₙ | (dL/g) | (kg/mol) | (kg/mol) | M_{w}/Mₙ |
| 24 | 0.37 | 14.0 | 22.6 | 1.61 | 0.50 | 17.5 | 25.5 | 1.45 |
| 48 | 0.44 | 13.4 | 21.5 | 1.60 | 0.46 | 17.3 | 24.7 | 1.43 |
| 72 | 0.45 | 15.1 | 25.5 | 1.68 | 0.39 | 14.1 | 19.5 | 1.38 |
| 96 | 0.57 | 16.8 | 28.5 | 1.70 | 0.56 | 20.5 | 29.7 | 1.45 |

As shown in Table 3, Mₙ, M_{w} and reduced viscosity of SPBe increased with reaction duration, whereas MWD had a relatively smaller increase. A higher reaction temperature (70° C.) increased not only the polymerization rate but also the molecular weights (Mₙ and M_{w}) and not at the expense of the MWD. The MWDs of the polymer obtained at 70° C. (average 1.4) appeared to become narrower than that of the polymerization conducted at room temperature (average 1.6) and were less dependent on the reaction time. The molecular weights at 70° C. did not increase with the reaction time as much as those at 25° C.

On the basis of these data, the polycondensation of UPEA was subsequently optimized to be carried out in DMA at 70° C. for 48 h (for a reaction as complete as possible), unless otherwise specified.

Elemental analysis results are set forth in Table 4 below:

TABLE 4

| | | Empirical Formula | Calculated (%) | | | Experimental (%) | | |
|---|---|---|---|---|---|---|---|---|
| Sample | Formula | (g/mol) | C | H | N | C | H | N |
| FPB | (C₂₆H₂₈N₂O₆)ₙ | 464.52n | 67.23 | 6.08 | 6.03 | 66.69 | 6.00 | 6.03 |
| FPH | (C₂₈H₃₂N₂O₆)ₙ | 492.57n | 68.28 | 6.55 | 5.69 | 67.02 | 6.43 | 5.56 |
| FPBe | (C₂₆H₂₆N₂O₆)ₙ | 462.50n | 67.52 | 5.67 | 6.06 | 65.86 | 5.62 | 5.92 |
| APBe | (C₂₈H₃₂N₂O₆)ₙ | 492.57n | 68.28 | 6.55 | 5.69 | 66.85 | 6.65 | 5.68 |
| SPBe | (C₃₂H₄₀N₂O₆)ₙ | 548.68n | 70.05 | 7.35 | 5.10 | 69.05 | 7.27 | 5.02 |

Fundamental properties of the synthesized UPEAs were determined and are set forth in Table 5 below:

TABLE 5

| | | | Reduced | | | | | |
|---|---|---|---|---|---|---|---|---|
| Empirical Formula | | Yield | Viscosity | Mₙ | M_{w} | | T_{g} | Tₘ |
| (FW) | | (%) | (dL/g)^{b} | (kg/mol) | (kg/mol) | M_{w}/Mₙ | (° C.) | (° C.) |
| FPB | C₂₆H₂₈N₂O₆)ₙ | 86 | 0.43 | — | — | — | 103 | ~250 |
| | [(464.53)ₙ] | | | | | | | |
| FPH | C₂₈H₃₂N₂O₆)ₙ | 87 | 0.30 | — | — | — | 92 | ~216 |
| | [(492.57)ₙ] | | | | | | | |
| FPBe | C₂₆H₂₆N₂O₆)ₙ | 74 | 0.35 | — | — | — | 109 | ~223 |
| | [(462.50)ₙ] | | | | | | | |
| APBe | C₂₈H₃₂N₂O₆)ₙ | 84 | 0.25 | 15.6 | 22.8 | 1.46 | 61 | N/A^{c} |
| | [(492.57)ₙ] | | | | | | | |
| SPBe | C₃₂H₄₀N₂O₆)ₙ | 54 | 0.46 | 17.3 | 24.7 | 1.43 | 46 | N/A^{c} |
| | [(548.68)ₙ] | | | | | | | |

^{a}Synthesis conditions: concentration = 10 mol/L, temperature = 70° C., DMA solvent.
^{b}Measured in m-cresol at 25° C. (concentration = 0.25 g/dl).
^{c}Polymer decomposed when the temperature was greater than 240° C.

The UPEAs exhibited a higher Tg than the corresponding saturated PEAs. This was because these UPEAs had one or two C═C double bonds in every repeating unit of the molecules. Such a structure reduced the flexibility of the polymer molecules and increased the difficulty of chain-segment movement (i.e., higher T_{g}).

For all five UPEAs, the location of the C═C double bond in the polymer backbone had a profound effect on T_{g}. FPBe, which had the C═C double bond in both the diester and diamide parts and thus the highest polymer chain rigidity, had the highest T_{g} (109° C.). The UPEAs based only on fumaryl, FPB and FPH, had the C═C double bond in the diamide part; the C═C double bonds also conjugated with the two carbonyl groups and resulted in a higher ridigidity of the polymer backbone. The butenyl-based UPEAs, APBe and SPBe, had isolated C═C double bonds in the diester part only; also, the 2-butene-1,4-diol used in the monomer synthesis for APBe and SPBe was a cis/trans mixture, which created some free volume that counteracted some of the rigid effect brought by C═C double bonds on the polymer molecules. Therefore, APBe and SPBe had much lower T_{g}'s than FPB and FPH.

On the other hand, the effect of the length of the methylene groups in the repeating unit of UPEAs on T_{g} can best be illustrated by a comparison of the T_{g} data for APBe and SPBe or for FPB and FPH. Such a comparison of T_{g} data indicated that those UPEAs with longer —CH₂— chain segments in their repeating units, such as SPBe and FPH, had lower T_{g}'s and the T_{g} of SPBe was the lowest of all five UPEAs. This relationship between T_{g} and the number of methylene groups in UPEA can be explained by the flexibility of the UPEA chain: more methylene groups in the UPEA backbone resulted in higher flexibility.

The difference in T_{g} (ΔT_{g}=6° C.) between FPBe and FPB was attributed to their structural differences: FPBe has C═C double bonds in both the diester and diamide parts, but FPB has a C═C bond in the diamide part only. This difference in T_{g} is much smaller than the difference between FPBe and APBe (ΔT_{g}>40° C.). Therefore, the T_{g}'s of the synthesized UPEAs were effected more by the C═C bond located in the diamide block than by that located in the diester block. This may be attributed to the conjugation effect between the C═C double bonds and the carbonyl groups in the diamide part, which had a greater restriction on the bond rotation of the polymers.

Because of their unsaturated structure and the conjugation effect between the C═C double bond and the carbonyl groups, the fumaryl-based UPEAs (FPB, FPH, and FPBe) had much higher Tₘ's than the corresponding saturated PEA reported previously. APBe and SPBe did not have Tₘ's and decomposed when the temperature was greater than 240° C.; this means that they did not have a crystalline structure.

Solubilities determined for the UPEAs (50 mg samples) at room temperature (25° C.) in 10 solvents (1 mL) are set forth in Table 6 below:

TABLE 6

| | APBe | SPBe | FPB | FPH | FPBe |
|---|---|---|---|---|---|
| H₂O | − | − | − | − | − |
| Formic Acid | + | + | − | − | ± |
| Trifluoroethanol | + | + | − | − | − |
| DMF | + | + | ± | ± | + |
| DMSO | + | + | + | ± | + |
| THF | + | + | − | − | − |
| Methanol | ± | − | − | − | − |
| Ethyl acetate | − | − | − | − | − |
| Chloroform | + | + | ± | − | − |
| Acetone | − | − | − | − | − |

^{a}+ soluble; − insoluble; ± partially soluble or swelling.

As indicated by Table 6, all the UPEAs were completely or partially soluble in DMSO and DMF but could not dissolve in water, ethyl acetate, or acetone. UPEAs with a single unsaturated bond in each repeating diester unit (e.g., SPBe and APBe) could also dissolve in trifluoroethanol, formic acid, THF, and chloroform. Among the five UPEAs, the fumaryl-based ones (FPB, FPBe, and FPH) had poorer solubility, and FPH had the poorest solubility, probably because of not only the strong hydrogen bonds between the molecules (via the amide group) but also the conjugation effect between the C═C double bonds and carbonyl groups, which did not exist in APBe and SPBe. FPH had the longest —CH₂— chain in its diester part of the five UPEAs, and it resulted in the strongest intermolecular interaction, the highest hydrophobicity, and thus the poorest solubility. The higher solubility of FPB in formic acid and DMF and that of FPH in DMSO were obtained at a higher temperature (e.g., 70° C.).

Wide angle X-ray diffraction was carried out on the UPEAs. Fumaryl-based UPEAs FPH and FPB had well-defined semicrystalline structures, which explained why FPH and FPB had obvious melting peaks, whereas FPBe had a smaller peak; the other two UPEAs with unsaturated bonds in the diester segment (APBe and SPBe) did not have enough crystallinity and just decomposed when heated above approximately 240° C. SPBe existed almost in an amorphous state, and this explains why SPBe had the best solubility in some organic solvents, in comparison with the other UPEAs.

The polymers were obtained in fairly good yields at 70° C. in 48 h with DMA as the solvent. The molecular weights (Mₙ and M_{w}) of SPBe and APBe, as measured by GPC, ranged from 10 to 30 kg/mol, and they had a rather narrow MWD of 1.40. The chemical structures of the UPEAs were confirmed by IR and NMR spectra. The UPEAs had higher T_{g}'s than saturated PEAs with similar backbone structures. The T_{g}'s of the synthesized polymers were affected more by the C═C double bond located in the diamide part than by that in the diester part. The solubility of the polymers was poor in water and better in DMA and DMSO.

### Background Example II

A further background example is provided by substituting p-toluenesulfonic acid salt of bis(L-phenylalanine) 2-butene-1,4-diester for (III) in Example 1 of U.S. Pat. No. 6,503,538 or by substituting di-p-nitrophenyl fumarate for (V) in Example 1 of U.S. Pat. No. 6,503,538 or by substituting p-toluenesulfonic acid salt of bis(L-phenylalanine) 2-butene-1,4-diester for (III) in Example 1 of U.S. Pat. No. 6,503,538 and also substituting di-p-nitrophenyl fumarate for (V) in Example 1 of U.S. Pat. No. 6,503,538.

### Example 1

An UPEA based on fumarate (FPB) is synthesized from p-toluenesulfonic acid salt of phenylalanine butane-1,4-diester and di-p-nitrophenyl fumarate. To a solution of FPB (0.93 g, 2 mmol) and AIBN (3.28 g, 20 mmol) in 20 mL of DMF, a 10-fold excess of 2-mercaptoethanol (1.76 mL, 20 mmol) was added. The reaction mixture was stirred at 70° C. for 24 h. The resulting product from this reaction was precipitated by pouring the solution into 400 mL of chilled diethyl ether. The final products were purified by precipitation using DMF as solvent and diethyl ether as non-solvent, filtered, and dry in vacuum overnight. This reaction was repeated using cysteamin and 3-mercaptopropionic acid with as the thiol-based compound. The reaction is exemplified as follows:

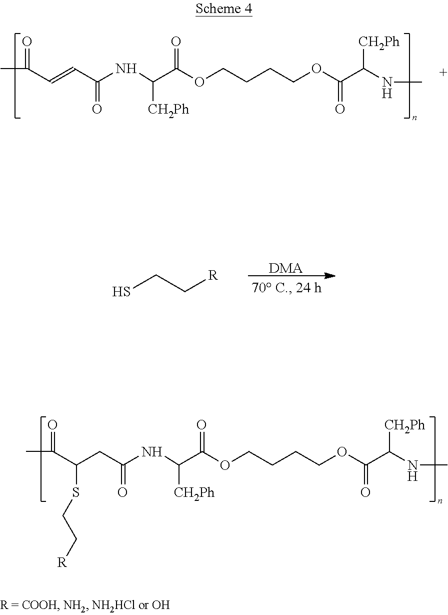

The solubility of the functionalized UPEAs having —COOH and —NH₂ were tested and are shown below in Table 7. The thermal properties of the functionalized UPEAs having —COOH, —OH, and —NH₂ were tested and are shown below in Table 8.

### Example 2

Triethylamine (0.31 mL, 2.2 mmol) is added dropwise to a mixture of monomers di-p-nitrophenyl adiapte (Ib, 0.7 mmol), di-p-Nitrophenyl fumurate, (Id, 0.3 mmol), and triethylene glycol (II, 1.0 mmol) in 1.5 mL of dry DMA, and the solution is heated to 60° C. with stirring until a complete dissolution of monomers. The reaction vial was then kept at 70° C. for 48 h without stirring. The copolymer in the solution was precipitated by adding chilled ethyl acetate, and the precipitate was filtered and then extracted by ethyl acetate in a Soxhlet apparatus for 48 hours and finally dried in vacuo at room temperature. The resulting copolymer (? g, ? mmol) is added to ? mL of DMF and reacted with an excess of 2-mercaptoethanol (? mL, ? mmol) was added. The reaction mixture was stirred at 70° C. for 24 h. The resulting product from this reaction was precipitated by pouring the solution into chilled diethyl ether. The final products were purified by precipitation using DMF as solvent and diethyl ether as non-solvent, filtered, and dry in vacuum overnight.

### Example 3

UPEA with —COOH attached at the carbon to carbon double bond within the UPEA was reacted with TEMPO in a solvent of DMA for three hours. The TEMPO molecule reacts with the —COOH group of the PEA.

The reaction is exemplified as follows:

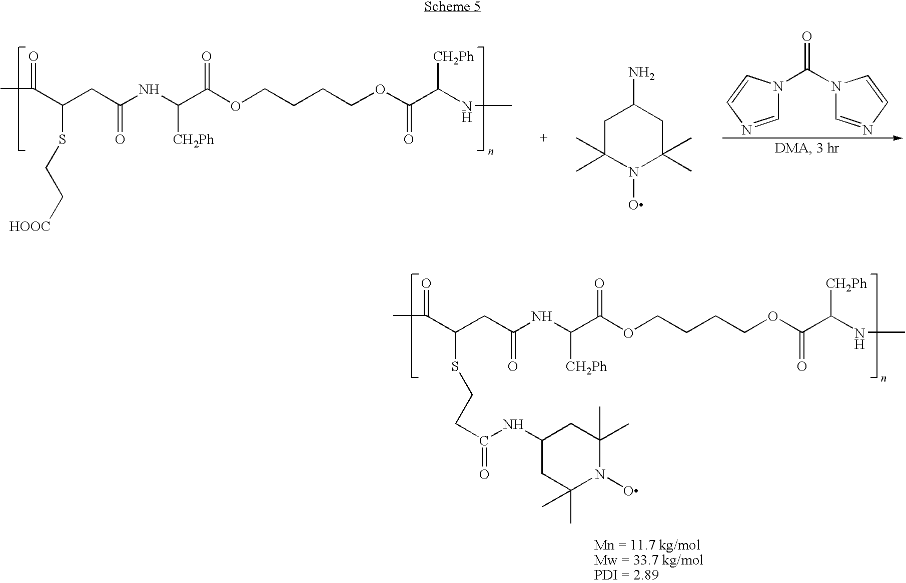

### Example 4

Triethylamine (0.31 mL, 2.2 mmol) is added dropwise to a mixture of monomers di-p-nitrophenyl adipate (lb, 0.7 mmol), di-p-Nitrophenyl fumurate, (Id, 0.3 mmol), and triethylene glycol (II, 1.0 mmol) in 1.5 mL of dry DMA, and the solution is heated to 60° C. with stirring until a complete dissolution of monomers occurs. The reaction vial is then kept at 70° C. for 48 h without stirring. The copolymer in the solution is precipitated by adding chilled ethyl acetate, and the precipitate is filtered and extracted by ethyl acetate in a Soxhlet apparatus for 48 hours and dried in vacuo at room temperature.

The resulting copolymer is added to DMF along with an excess of 2-mercaptoethanol forming a reaction mixture. The reaction mixture is stirred at 70° C. for 24 h. The resulting product from this reaction is precipitated by pouring the solution into chilled diethyl ether. The final products are purified by precipitation using DMF as solvent and diethyl ether as non-solvent, filtered, and dry in vacuum overnight.

TABLE 7

| | H2O | FA | TFE | DMF | DMSO | THF | MeOH | EA | CHCl3 | Acetone |
|---|---|---|---|---|---|---|---|---|---|---|
| FPB-COOH | − | + | + | + | + | − | − | − | − | − |
| FPB-NH2 | − | + | + | + | + | − | − | − | − | − |
| FP3EG-COOH | − | + | + | + | + | | | − | | |
| FP3EG-NH2 | − | + | + | + | + | | | − | | |

FA: Formic Acid;
TFE: Trifluoroethano;
MeOH: Methanol;
EA: Ethyl Acetate;
CHCl3: Chloroform
*FPB-COOH and FP3EG-COOH can also dissolve in basic aqueous solution, pH = 10; FPB-NH2 can NOT dissolve in acidic aqueous solution, pH = 4.

TABLE 8
Thermal Properties - Glass transition
(Tg) and Melting temperatures (Tm)

| | Tg (C.) | Tm (C.) |
|---|---|---|
| FPB | 103 | ~250 |
| FPB-COOH | 68 | N/A |
| FPB-NH2 | 68 | N/A |
| FPB-OH | | |
| FP3EG | 67 | 180 |
| FP3EG-COOH | 44 | N/A |
| FP3EG-NH2 | 37 | 176 |

### Variations

The foregoing description of the invention has been presented describing certain operable and preferred embodiments. It is not intended that the invention should be so limited since variations and modifications thereof will be obvious to those skilled in the art, all of which are within the spirit and scope of the invention.

What is claimed is:

1. A polymer having the structural formula: 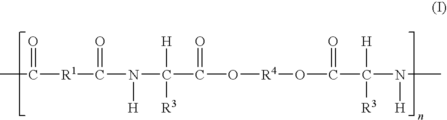
wherein R¹ is (C₂-C₂₈)alkylene, or (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt;
R³ is selected from the group consisting of hydrogen, (C₁-C₆)alkyl, and (C₆-C₁₀)aryl (C₁-C₆)alkyl; and
R⁴ is selected from the group consisting of (C₂-C₂₈)alkyloxy, (C₂-C₂₈)alkylene, (C₂-C₂₈)alkyloxy substituted with a side chain selected from the group consisting of (2-carboxyethyl)thio, (2-hydroxethyl)thio, (2-aminoethyl)thio and (2-aminoethyl)thio hydrochloride salt, and —C₂H₄ (OC₂H₄)ₓ, or (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt, and —C₂H₄(OC₂H₄)ₓ;
x ranges from 2-4;
n ranges from 5 to 150; and
wherein at least one of R1 and R4 attaches a functional group.

2. The polymer according to claim 1, wherein the side chain is (2-carboxyethyl)thio.

3. The polymer according to claim 1, wherein the side chain is (2-hydroxethyl)thio.

4. The polymer according to claim 1, wherein the side chain is (2-aminoethyl)thio.

5. The polymer according to claim 1, wherein the side chain is (2-carboxyethyl)thio.

6. The polymer according to claim 1, wherein the side chain is (2-hydroxethyl)thio.

7. The polymer according to claim 1, wherein the side chain is (2-aminoethyl)thio hydrochloride salt.

8. A polymer having the structural formula: 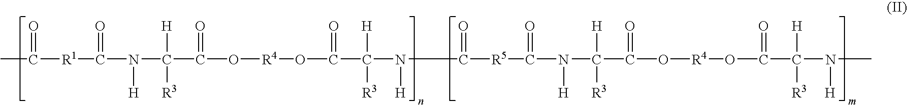
wherein R¹ is (C₂-C₂₈)alkylene, or (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt;
R³ is selected from the group consisting of hydrogen, (C₁-C₆)alkyl, and (C₆-C₁₀)aryl;
R⁴ is selected from the group consisting of (C₂-C₂₈)alkyloxy, (C₂⁻C₂₈)alkylene, (C₂-C₂₈)alkyloxy substituted with a side chain selected from the group consisting of (2-carboxyethyl)thio, (2-hydroxethyl)thio, (2-aminoethyl)thio and (2-aminoethyl)thio hydrochloride salt, and —C₂H₄(OC₂H₄)ₓ, or (C₂-C₂₈)alkylene substituted with a side chain selected from the group consisting of (2-carboxyethyl)thio, (2-hydroxethyl)thio, (2-aminoethyl)thio and (2-aminoethyl)thio hydrochloride salt, and —C₂H₄(OC₂H₄)ₓ;
R⁵ is (C₂-C₂₀)alkylene;
n ranges from 0.9 to 0.1;
m ranges from 0.1 to 0.9; and
wherein at least one of R1 and R4 attaches a functional group.

9. The block copolymer according to claim 8, wherein the side chain is (2-carboxyethyl)thio.

10. The polymer according to claim 8, wherein the side chain is (2-hydroxethyl)thio.

11. polymer according to claim 8, wherein the side chain is (2-aminoethyl)thio.

12. The polymer according to claim 8, wherein the side chain is (2-carboxyethyl)thio.

13. The polymer according to claim 8, wherein the side chain is (2-hydroxethyl)thio.

14. The polymer according to claim 8, wherein the side chain is (2-aminoethyl)thio hydrochloride salt.
